(19) United States
(12) Patent Application Publication
(10) Pub. No.: US 2021/0141675 A1
(43) Pub. Date: May 13, 2021

(54) HOTPLUGGABLE RUNTIME

(71) Applicant: Intel Corporation, Santa Clara, CA (US)

(72) Inventors: Shao-Wen Yang, San Jose, CA (US); Subramanya R. Dulloor, Santa Clara, CA (US); Yen-Kuang Chen, Palo Alto, CA (US)

(73) Assignee: Intel Corporation, Santa Clara, CA (US)

(21) Appl. No.: 16/488,576

(22) PCT Filed: Apr. 1, 2017
(86) PCT No.: PCT/US17/25637

§ 371 Date: Aug. 23, 2019

(51) Int. Cl. G06F 9/50; G06F 9/48; G06F 13/40

(52) U.S. Cl. CPC G06F 9/5083; G06F 13/4081; G06F 9/4862; G06F 9/5016

(57) ABSTRACT

Availability of computing resources is detected on a particular device in a network and a runtime core is caused to be loaded on the particular device based on the availability. The runtime core is configured to support hot-plugging of code embodying any one of a plurality of job and first code comprising a placeholder job is caused to be run on the runtime core to reserve at least a portion of the computing resources of the particular device. A particular one of the plurality of jobs to be run on the particular device is identified and the first code is replaced with second code corresponding to the particular job to replace the placeholder job on the runtime core.

### TECHNICAL FIELD

This disclosure relates in general to the field of computer systems and, more particularly, to migrating jobs within a distributed software system.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow a new era of advanced automation and interconnectivity, referred to, sometimes, as the Internet of Things (IoT).

### BRIEF DESCRIPTION OF THE DRAWINGS

FIG. 1A illustrates an embodiment of a system including multiple sensor devices and an example management system;

FIG. 1B illustrates an embodiment of a cloud computing network;

FIG. 2 illustrates an embodiment of a system including an example declarative programming tool;

FIG. 3 is a simplified block diagram of an example computing system including edge devices;

FIG. 4 are simplified block diagrams illustrating example offloading of jobs in a computing system;

FIG. 5 is a simplified block diagram illustrating example offloading of jobs to be run on runtime cores in a computing system;

FIG. 6 is a simplified block diagram illustrating example offloading of jobs in a visual computing system;

FIG. 7 is a flowchart illustrating an example technique for example offloading of jobs in a computing system;

FIG. 8 is a block diagram of an exemplary processor in accordance with one embodiment; and

FIG. 9 is a block diagram of an exemplary computing system in accordance with one embodiment.

Like reference numbers and designations in the various drawings indicate like elements.

### DETAILED DESCRIPTION OF EXAMPLE EMBODIMENTS

FIG. 1A is a block diagram illustrating a simplified representation of a system 100 that includes one or more devices 105a-d, or assets, deployed throughout an environment. Each device 105a-d may include a computer processor and/or communications module to allow each device 105a-d to interoperate with one or more other devices (e.g., 105a-d) or systems in the environment. Each device can further include one or more instances of various types of sensors (e.g., 110a-c), actuators (e.g., 115a-b), storage, power, computer processing, and communication functionality which can be leveraged and utilized (e.g., by other devices or software) within a machine-to-machine, or Internet of Things (IoT) system or application. Sensors are capable of detecting, measuring, and generating sensor data describing characteristics of the environment in which they reside, are mounted, or are in contact with. For instance, a given sensor (e.g., 110a-c) may be configured to detect one or more respective characteristics such as movement, weight, physical contact, temperature, wind, noise, light, computer communications, wireless signals, position, humidity, the presence of radiation, liquid, or specific chemical compounds, among several other examples. Indeed, sensors (e.g., 110a-c) as described herein, anticipate the development of a potentially limitless universe of various sensors, each designed to and capable of detecting, and generating corresponding sensor data for, new and known environmental characteristics. Actuators (e.g., 115a-b) can allow the device to perform (or even emulate) some kind of action or otherwise cause an effect to its environment (e.g., cause a state or characteristics of the environment to be maintained or changed). For instance, one or more of the devices (e.g., 105b, d) may include one or more respective actuators that accepts an input and perform its respective action in response. Actuators can include controllers to activate additional functionality, such as an actuator to selectively toggle the power or operation of an alarm, camera (or other sensors), heating, ventilation, and air conditioning (HVAC) appliance, household appliance, in-vehicle device, lighting, among other examples. Actuators may also be provided that are configured to perform passive functions.

In some implementations, sensors 110a-c and actuators 115a-b provided on devices 105a-d can be assets incorporated in and/or forming an Internet of Things (IoT) or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected devices (e.g., 105a-d), such as devices sourced or controlled by varied groups of entities and employing varied hardware, operating systems, software applications, and technologies.

In some implementations, a collection of devices (e.g., 105a-d) may be configured (e.g., by a management system 140) to operate together as an M2M or IoT system and sensors (e.g., 110a-c) hosted on at least some of the devices may generate sensor data that may be acted upon according to service logic implementing an IoT application using the collection of devices. According to the service logic, some of the sensor data may be provided (e.g., with or without pre-processing by the management system 140, a backend service (e.g., 145), another device, or other logic) to other devices (e.g., 105b, d) possessing actuator assets (e.g., 115a-b), which may cause certain actions to be performed based on sensor-data-based inputs. As alluded to above, sensor data may be processed by computer-executed logic at one or more devices within the system to derive an input to be sent to an actuator asset. For instance, machine learning, transcoding, formatting, mathematic and logic calculations, heuristic analysis, and other processing may be performed on sensor data generated by the sensor assets. Inputs, or commands, sent to actuator assets may be reflect the results of this additional processing. As a practical example, in the field of autonomous vehicles, camera, infrared, radar, or other sensor assets may be provided on a vehicle and the raw sensor data generated from these assets may be provided for further processing by one or more devices possessing computing resources and executable logic capable of performing the processing. For instance, machine learning, artificial intelligence, distance and speed computation logic, and/or other processes may be provided by devices to operate on the raw sensor data. The results of these operations may produce outputs indicating a potential collision and these outputs may be provided to actuator assets (e.g., automated steering, speed/engine control, braking, or other actuators) to cause the autonomous vehicle to respond to the findings of the sensors. In some instances, the “job” logic used to perform this processing may be provided on a single, centralized computing device (e.g., the management system, a gateway device, backend service, etc.). While jobs requiring more intensive computing or memory resources may be advantageously handled by machines possessing the processing and memory to do so, such implementations may create bottlenecks or may be otherwise disadvantageous in distributed systems, particularly where sensor data is being provided as inputs from numerous (in some cases 1000's) of different devices to a single or otherwise centralized system for processing. Further, instances may arise where the centralized system is unable to handle all of the inputs and corresponding jobs to operate on these inputs during certain windows of time.

Accordingly, in some implementations, jobs corresponding to the processing of inputs from various data sources (e.g., sensor assets) may be at least partially and/or occasionally delegated to other devices, including devices not typically thought of as capable of handling such processing. For instance, many specialized IoT devices (e.g., 105a-d), while not specifically designed for data processing jobs, may possess computing and memory resources in order to perform their core functions. In some implementations, these computing and memory resources may be utilized to perform smaller jobs (e.g., whole or portions of “whole” jobs) in lieu of or to supplement processing by a dedicated, centralized system. Indeed, in some instances, jobs or portions of jobs (collectively referred to hereafter as “jobs” for simplicity) may be migrated from an initial device tasked with handling the job to another device, which may take over or perform other portions of the job. In still other examples, a centralized, general purpose computing system may be omitted from an IoT or M2M solution, with data processing jobs performed instead using the distributed computing and memory resources already present within the system on the various IoT devices provided in the system. Indeed, some IoT devices may both generate the data inputs to be processed as well as perform processing jobs (e.g., on local data or data generated by other assets, etc.) within the system.

As shown in the example of FIG. 1A, multiple IoT devices (e.g., 105a-d) can be provided from which one or more different IoT applications can be built. For instance, a device (e.g., 105a-d) can include such examples as a mobile personal computing device, such as a smart phone or tablet device, a wearable computing device (e.g., a smart watch, smart garment, smart glasses, smart helmet, headset, etc.), purpose-built devices such as and less conventional computer-enhanced products such as home, building, vehicle automation devices (e.g., smart heat-ventilation-air-conditioning (HVAC) controllers and sensors, light detection and controls, energy management tools, etc.), smart appliances (e.g., smart televisions, smart refrigerators, etc.), and other examples. Some devices can be purpose-built to host sensor and/or actuator resources, such as a weather sensor devices that include multiple sensors related to weather monitoring (e.g., temperature, wind, humidity sensors, etc.), traffic sensors and controllers, among many other examples. Some devices may be statically located, such as a device mounted within a building, on a lamppost, sign, water tower, secured to a floor (e.g., indoor or outdoor), or other fixed or static structure. Other devices may be mobile, such as a sensor provisioned in the interior or exterior of a vehicle, in-package sensors (e.g., for tracking cargo), wearable devices worn by active human or animal users, an aerial, ground-based, or underwater drone among other examples. Indeed, it may be desired that some sensors move within an environment and applications can be built around use cases involving a moving subject or changing environment using such devices, including use cases involving both moving and static devices, among other examples. While some devices (e.g., 105a-d) may be purpose-built devices configured to perform particular jobs or generate particular data, other devices (e.g., 125, 130, 135) may be mobile general purpose devices capable of being flexibly added or removed from a network, the general purpose devices equipped with a combination of various computing, memory, operating system, and sensor elements, allowing the devices (e.g., smart phones, tablet computers, laptops, etc.) to flexibly execute a variety of software programs and perform a variety of different functions. The component assets (e.g., particular sensors, computing resources, particular actuators, etc.) of a general purpose device (e.g., 125, 130, 135) may be combined with assets (e.g., 110a-c, 115a-b) of special purpose devices (e.g., 105a-d) to form IoT systems in some examples.

Given the variety and diversity of devices (e.g., 105a-d, 125, 130, 135), which may be utilized within an IoT or other M2M system, it should be appreciated that the computing, memory, and communications resources of the various devices may be similarly diverse. In some cases, a device may be relatively “dumb” and may not possess the minimum computing resources to allow jobs to be delegated or assigned to it. Other devices may possess sufficient computing resources, although some of these “smarter” devices may possess relatively larger computing and memory capacity, allowing these devices to be more frequently or preferably tasked with performing data processing jobs. In still other examples, some devices may possess comparably large amounts of computing power and memory, but may possess less free capacity for handling data processing jobs for the IoT system because the native or core functionality (e.g., software) may place high demands on the device's resources, while other seemingly less-powerful devices may possess higher capacity for handling data processing jobs due to under-use of the device's computing resources and/or memory, among other examples.

Continuing with the example of FIG. 1A, software-based IoT management platforms (e.g., 140) can be provided to allow developers and end users to build and configure IoT applications and systems, as well as manage these systems. An IoT application can provide software support to organize and manage the operation of a set of IoT device for a particular purpose or use case. In some cases, an IoT application can be embodied as an application on an operating system of a general purpose computing device (e.g., 125) or a mobile app for execution on a smart phone, tablet, smart watch, or other mobile device (e.g., 130, 135). In some cases, the application can have an application-specific management utility allowing users to configure settings and policies to govern how the set devices (e.g., 105a-d) are to operate within the context of the application. A management utility can also be used to select which devices are used with the application. In other cases, a dedicated IoT management application can be provided which can manage potentially multiple different IoT applications or systems. The IoT management application, or system, may be hosted on a single system, such as a single server system (e.g., 140) or a single end-user device (e.g., 125, 130, 135). Alternatively, an IoT management system can be distributed across multiple hosting devices and systems (e.g., 125, 130, 135, 140, etc.).

Still further, management systems 140 may be provided, which may be further or alternatively utilized to manage data processing workloads within the system. In some implementations, some features of an IoT system to be deployed may demand low latency data processing, and the management system 140 may be operable to proactively delegate data processing jobs on-demand to a variety of different devices (e.g., based on their capacity), as well as prepare these devices to seamlessly handle various jobs as may be determined by the management system 140.

In some cases, IoT systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, the IoT system can connect to a remote service (e.g., hosted by an application server 145) over one or more networks 120. In some cases, the remote service can, itself, be considered an asset of an IoT application. Data received by a remotely-hosted service can be consumed by the governing IoT application and/or one or more of the component IoT devices to cause one or more results or actions to be performed, among other examples.

One or more networks (e.g., 120) can facilitate communication between sensor devices (e.g., 105a-d), end user devices (e.g., 125, 130, 135), and other systems (e.g., 140, 145) utilized to implement and manage IoT applications in an environment. Such networks can include wired and/or wireless local networks, public networks, wide area networks, broadband cellular networks, the Internet, and the like.

In general, “servers,” “clients,” “computing devices,” “network elements,” “hosts,” “system-type system entities,” “user devices,” “gateways,” “IoT devices,” “sensor devices,” and “systems” (e.g., 105a-d, 125, 130, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1A is described as containing or being associated with a plurality of elements, not all elements illustrated within computing environment 100 of FIG. 1A may be utilized in each alternative implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

As noted above, a collection of devices, or endpoints, may participate in Internet-of-things (IoT) networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

As shown in the simplified block diagram 101 of FIG. 1B, in some instances, a cloud computing network, or cloud, in communication with a mesh network of IoT devices (e.g., 105a-d), which may be termed a “fog,” may be operating at the edge of the cloud. To simplify the diagram, not every IoT device 105 is labeled.

The fog 170 may be considered to be a massively interconnected network wherein a number of IoT devices 105 are in communications with each other, for example, by radio links 165. This may be performed using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

Three types of IoT devices 105 are shown in this example, gateways 150, data aggregators 175, and sensors 180, although any combinations of IoT devices 105 and functionality may be used. The gateways 150 may be edge devices that provide communications between the cloud 160 and the fog 170, and may also function as charging and locating devices for the sensors 180. The data aggregators 175 may provide charging for sensors 180 and may also locate the sensors 180. The locations, charging alerts, battery alerts, and other data, or both may be passed along to the cloud 160 through the gateways 150. As described herein, the sensors 180 may provide power, location services, or both to other devices or items.

Communications from any IoT device 105 may be passed along the most convenient path between any of the IoT devices 105 to reach the gateways 150. In these networks, the number of interconnections provide substantial redundancy, allowing communications to be maintained, even with the loss of a number of IoT devices 105.

The fog 170 of these IoT devices 105 devices may be presented to devices in the cloud 160, such as a server 145, as a single device located at the edge of the cloud 160, e.g., a fog 170 device. In this example, the alerts coming from the fog 170 device may be sent without being identified as coming from a specific IoT device 105 within the fog 170. For example, an alert may indicate that a sensor 180 needs to be returned for charging and the location of the sensor 180, without identifying any specific data aggregator 175 that sent the alert.

In some examples, the IoT devices 105 may be configured using an imperative programming style, e.g., with each IoT device 105 having a specific function. However, the IoT devices 105 forming the fog 170 may be configured in a declarative programming style, allowing the IoT devices 105 to reconfigure their operations and determine needed resources in response to conditions, queries, and device failures. Corresponding service logic may be provided to dictate how devices may be configured to generate ad hoc assemblies of devices, including assemblies of devices which function logically as a single device, among other examples. For example, a query from a user located at a server 145 about the location of a sensor 180 may result in the fog 170 device selecting the IoT devices 105, such as particular data aggregators 175, needed to answer the query. If the sensors 180 are providing power to a device, sensors associated with the sensor 180, such as power demand, temperature, and the like, may be used in concert with sensors on the device, or other devices, to answer a query. In this example, IoT devices 105 in the fog 170 may select the sensors on particular sensor 180 based on the query, such as adding data from power sensors or temperature sensors. Further, if some of the IoT devices 105 are not operational, for example, if a data aggregator 175 has failed, other IoT devices 105 in the fog 170 device may provide substitute, allowing locations to be determined.

Further, the fog 170 may divide itself into smaller units based on the relative physical locations of the sensors 180 and data aggregators 175. In this example, the communications for a sensor 180 that has been instantiated in one portion of the fog 170 may be passed along to IoT devices 105 along the path of movement of the sensor 180. Further, if the sensor 180 is moved from one location to another location that is in a different region of the fog 170, different data aggregators 175 may be identified as charging stations for the sensor 180.

As an example, if a sensor 180 is used to power a portable device in a chemical plant, such as a personal hydrocarbon detector, the device will be moved from an initial location, such as a stockroom or control room, to locations in the chemical plant, which may be a few hundred feet to several thousands of feet from the initial location. If the entire facility is included in a single fog 170 charging structure, as the device moves, data may be exchanged between data aggregators 175 that includes the alert and location functions for the sensor 180, e.g., the instantiation information for the sensor 180. Thus, if a battery alert for the sensor 180 indicates that it needs to be charged, the fog 170 may indicate a closest data aggregator 175 that has a fully charged sensor 180 ready for exchange with the sensor 180 in the portable device.

Edge or endpoint devices, such as those utilized and deployed for potential inclusion in IoT systems, may likewise be utilized within “fog” computing solutions. In some cases, “fog” is a paradigm for collaboratively using edge devices, intermediate gateways, and servers on premise or in the cloud as the computing (e.g., data processing) platform. As the number of edge devices are believed to grow dramatically in number, the potential applicability and promise of fog computing brightens. However, the delegation and distribution of jobs within a fog system may be, itself, a resource-intensive process and encourages static delegation of jobs to edge devices to mitigate against the cost in time, resources, and latency for continuous and flexible delegation and offloading of jobs on-demand. Indeed, some applications may be particular sensitive to latency or may advantageously vary the jobs that any one fog edge device may be called upon to perform.

Offloading, within such solutions, may refer to a technique for a device to outsource a job to another device for potentially better efficiency, lower latency, lower power consumption, etc. For instance, in some implementations, a device's resource availability and a job's resource requirements may be monitored and used as a basis for determining whether or not to outsource the particular job to the particular device (or any edge device) by taking into account heterogeneous resource capacities, e.g., CPU, GPU and FPGA, and link capacities, such as bandwidth, latency and power consumption, among other examples. Further, as computation resources become increasingly ubiquitous given the increasing number and deployment of such computing devices as wearables, smartphones, laptops, PCs, cloud servers, etc., the fog paradigm further opens the possibility to offload analytics tasks from the cloud back to edge and intermediate devices for better efficiency. However, while computation can be shared by numerous devices around the fog paradigm; on the other hand, in particular for video analytics, bandwidth requirements can be significantly reduced when data are processed and abstracted into higher level metadata before transmitting over a network, making use of fog solutions problematic in applications calling for low latency, such as some data center applications, video analytics, visual computing, etc. In some implementations, such as introduced in the examples herein, fog systems may be supported through a framework that allows offloading or outsourcing of jobs from the cloud, a central processing system, or edge device to another edge device (or any intermediate devices). Successful offloading may improve scalability of analytics tasks, for instance, as reduced bandwidth consumption may imply processing of more simultaneously delivered data (e.g., continuous video streams) in substantially real time, among other example solutions and advantages.

In some implementations, an improved system may be provided with enhancements to address at least some of the example issues above. Such systems may include machine logic implemented in hardware and/or software to implement the features, functionality, and solutions introduced herein and address at least some of the example issues above (among others). For instance, FIG. 2 shows a simplified block diagram 200 illustrating a system including multiple IoT devices (e.g., 105a-b) with assets (e.g., sensors (e.g., 110a) and/or actuators (e.g., 115a)) capable of being used potentially in a variety of different IoT applications. In the example of FIG. 2, a management system 140 may be provided with system manager logic 205 (implemented in hardware and/or software) to detect assets within a location, identify opportunities to deploy and facilitate deployment of an IoT system utilizing the detected assets. The same (or a different, distinct) management system 140 may host workload manager 210 logic capable of managing job workflows to offload and migrate data processing jobs one edge devices (e.g., 105a-b) in the system.

In the particular example of FIG. 2, the management system 140 may include one or more data processing apparatus (or “processors”) 212, one or more memory elements 213, and one or more communication modules 214 incorporating hardware and logic to allow the gateway to communicate over one or more networks (e.g., 120), utilizing one or a combination of different technologies (e.g., WiFi, Bluetooth, Near Field Communications, Zigbee, Ethernet, etc.), with other systems and device. The system manager 205 and workload manager 210, etc. may be implemented utilizing code accessible and executable by the processor 212 to manage the automated deployment of a local IoT system.

In one example, a system manager 210 may possess logic to discover devices (e.g., 105a-b) within an environment, together with their respective capabilities, and automate deployment of an IoT application using a collection of these devices. For instance, system manager 210 may possess asset discovery functionality to determine which IoT devices are within a spatial location, on a network, or otherwise within “range” of the management system's control. In some implementations, the system manager 205 may perform asset discovery module through the use of wireless communication capabilities (e.g., 214) of the management system 140 to attempt to communicate with devices within a particular radius. For instance, devices within range of a WiFi or Bluetooth signal emitted from the antenna(e) of the communications module(s) 214 of the gateway (or the communications module(s) (e.g., 262, 264) of the assets (e.g., 105a,d)) can be detected. Additional attributes can be considered during asset discovery when determining whether a device is suitable for inclusion in a listing of devices for a given system or application. In some implementations, conditions can be defined for determining whether a device should be included in the listing. For instance, the system manager 205 may attempt to identify, not only that it is capable of contacting a particular asset, but may also determine assets such as physical location, semantic location, temporal correlation, movement of the device (e.g., is it moving in the same direction and/or rate as the discovery module's host), permissions or access level requirements of the device, among other characteristics. As an example, in order to deploy smart lighting control for every room in a home- or office-like environment, an application may be deployed in a “per room basis.” Accordingly, the asset discovery logic of the system manager 205 can determine a listing of devices that are identified (e.g., through a geofence or semantic location data reported by the device) as within a particular room (despite the system manager 205 being able to communicate with and detect other devices falling outside the desired semantic location).

Discovery conditions may be based or defined according to asset capabilities needed for the system. For instance, criteria can be defined to identify which types of resources are needed or desired to implement an application. Such conditions can go beyond proximity, and include identification of the particular types of assets that the application is to use. For instance, the system manager 205 may additionally identify attributes of the device, such as its model or type, through initial communications with a device, and thereby determine what assets and asset types (e.g., specific types of sensors, actuators, memory and computing resources, etc.) are hosted by the device. Accordingly, discovery conditions and criteria can be defined based on asset type abstractions (or asset taxonomies) and a type of job to be performed (e.g., a job abstraction, such as an ambient abstraction) defined for the IoT application. Some criteria may be defined that is specific to a particular asset types, where the criteria has importance for some asset types but not for others in the context of the corresponding IoT application. Further, some discovery criteria may be configurable such that a user can custom-define at least some of the criteria or preferences used to select which devices to utilize in furtherance of an IoT application (e.g., through definition of new abstractions to be included in one or more abstraction layers embodied in abstraction data).

A system manager 205 can also include functionality enabling it to combine automatic resource management/provisioning with auto-deployment of services. Further, a system manager 205 can allow resource configurations from one IoT system to be carried over and applied to another so that services can be deployed in various IoT systems. Additionally, the system manager 205 can be utilized to perform automated deployment and management of a service resulting from the deployment at runtime. Auto-configuration can refer to the configuration of devices with configurations stored locally or on a remote node, to provide assets (and their host devices) with the configuration information to allow the asset to be properly configured to operate within a corresponding IoT system. As an example, a device may be provided with configuration information usable by the device to tune a microphone sensor asset on the device so that is might properly detect certain sounds for use in a particular IoT system (e.g., tune the microphone to detect specific voice pitches with improved gain). Auto-deployment of a services may involves identification (or discovery) of available devices, device selection (or binding) based on service requirements (configuration options, platform, and hardware), and automated continuous deployment (or re-deployment) to allow the service to adapt to evolving conditions.

In one example, a system manager 205 may be utilized to direct the deployment and running of a service on a set of devices within a location. The system manager 205 may further orchestrate the interoperation, communications, and data flows between various devices (e.g., 105a-b) within a system according to an IoT application. Indeed, in some cases, system manager 205 may itself utilize service logic corresponding to an IoT application and be provided with sensor data as inputs to the logic and use the service logic to generate results, including results which may be used to prompt certain actuators on the deployed devices (e.g., in accordance with job abstractions defined for the corresponding application). For instance, sensor data (pre- or post-processing) may be sent to the system manager 205 and the system manager 205 may route this data to other assets in the system (e.g., computing assets (e.g., executing data processing jobs), actuator assets, memory assets, etc.). In still other examples, the system manager may include data processing logic to process the data it receives in order to generate inputs for other assets (e.g., actuator assets (e.g., 115a) in the system.

In some implementations, a system manager 205 may interface with and interoperate with a workload manager 210 tasked with managing the offloading, migration, and/or delegation of data processing jobs. As noted above, the system manager 205 may, itself, perform some data processing jobs and may, in some implementations, make use of the workload manager 210 to offload the data processing jobs to other computing resources in the system (e.g., devices 105a-b). In some implementations, systems other than the system manager 205 may additionally or alternatively be primarily tasked with certain data processing jobs and the workload manager 210 may likewise monitor these systems to determine opportunities for offloading some jobs onto other devices, such as edge or fog devices (e.g., 105a-b). In still other examples, no centralized data processing resources may be provided in a system and all data processing jobs of some types may be handled by fog-based resources, with the workload manager 210 responsible for determining which devices to invoke, prepare, and offload these jobs to.

In the example of FIG. 2, an example workload manager 210 may include logical components such as an asset manager 215, capacity monitor 220, and job assignment engine 225, among potentially other examples or divisions or combinations of the foregoing. In one implementation, an asset manager 215 may be provided to identify the collection of devices from which the workload manager 210 may potentially pool computing resources. For instance, the asset manager 215 can determine a number of devices with which the workload manager may communicate with (e.g., over network 120) and is allowed to (e.g., has permission) make use of. The asset manager 215 may further determine the respective resources on each of the devices in the collection to determine the maximum amount and type of computing, memory, and communications resources present on each device. The asset manager 215 may also determine which of these devices is presently capable of having jobs delegated to the device. For instance, a framework may be provided that makes use of runtime cores (e.g., 230a-b) and job plugins (e.g., 235a-b), and the asset manager 215 may determine, whether each device has been provisioned with the logic (e.g., 282, 284) for utilizing the job execution framework(s) supported by the workload manager 210. In cases where the workload manager 210 determines that a device (e.g., 105a-b) possesses sufficient computing resources (e.g., 266, 268) to potentially take part in job offloading, but does not yet possess the logic (e.g., 282, 284) to actually take part, the asset manager 215 may provide this logic (e.g., by pushing or offering such logic (e.g., 282, 284) for installation on the devices (e.g., 105a-b) over a network 120. Asset manager 215 may additionally collect and maintain various metadata and other information describing the catalogue of devices (e.g., 105a-b) which the workload manager 210 may make use of, such as information pertaining to the addressing of the device, historical capacity trends of the device, descriptions of the device's usable assets (e.g., processing speed, amount of memory, communications bandwidth, hardware details, etc.), and information detailing current and past use the device in offloading (e.g., the types and volume of jobs handled by the device, performance data describing the device's performance during the jobs, date/time of the jobs, the amount of capacity available when the job was performed, the capacity utilized for the jobs, etc.).

A workload manager 210 may additionally possess a capacity monitor 220, which may provide functionality for monitoring devices within a system to identify or predict available computing capacity at the device, which may be taken advantage of in the offloading of one or more jobs to the device (e.g., 105a-b). The capacity monitor 220, for instance, may interface with devices (or other systems managing these devices) and directly access status information or query the device(s) for status information to determine the present status of the device, and in particular, the status of processing (e.g., 266) and/or memory resources (e.g., 270) of the device (e.g., 105a). The capacity monitor 220 may detect and determine effectively real-time capacity of various devices. The capacity monitor 220, in some implementations, may additionally request capacity from devices, such that the capacity inquires whether a particular amount of capacity may be made available by the device within an upcoming window (or time multiplexed window) of time. In this sense, the capacity monitor 220 may determine future or upcoming available capacity at a device. In still other examples, the capacity monitor 220 may predict capacity of a device at some future window of time. For instance, the capacity monitor 220 may interface with asset manager 215 to obtain historical information for a particular device as well as historical information for the performance of a given job or type of job using other (similar) devices, among other examples. The capacity monitor 220 may utilize historical job offloading performance information (e.g., collected in the past by the asset manager 215) to predict available capacity. In some implementations, the capacity monitor 220 may make use of machine learning or other trained or predictive algorithms to determine future capacity of a particular device, for instance, based on present capacity information for the device and historical capacity and job performance information for the device, among other examples.

In addition to identifying available capacity of devices (e.g., 105a-b) within a system, the capacity monitor 220, in some implementations, may additionally possess functionality for determining diminishing computing capacity in other systems from which jobs may be potentially migrated. In such instances, the capacity monitor 220 may also monitor the performance of jobs or a flow of jobs by one or more systems. For instance, various data sources (e.g., 245), including the devices (e.g., 105a-b) in the detected collection of devices may generate various flows of data that are to be processed according to one or more types of jobs. As data generation and inflow increases, the capacity of a system (e.g., 250) or device (e.g., 105a-b) originally tasked with handling these jobs may be overwhelmed. For instance, processing (e.g., 262) and/or memory (e.g., 264) resources of a particular system (e.g., 250) may be determined to be insufficient to perform a set of jobs (e.g., according to certain latency or other standards) originally intended for the system (e.g., 250). In such instances, a capacity monitor 220 may monitor the performance of systems originally tasked with the performance of jobs to identify opportunities for migration, delegation, or other offloading of jobs. For instance, a capacity monitor 220 may interface with such systems (as with the determination of excess or available computing capacity) to determine or predict (e.g., from machine learning techniques and/or from historical performance data) a need or opportunity to offload some or a portion of jobs currently performed by the system, among other examples.

A workload manager 210 may additionally include logic (e.g., 225) to perform and/or manage the performance of job offloading within a system. For instance, a job assignment engine 225 may be provided to identify jobs that are currently being completed and could use assistance through offloading or upcoming jobs that are to be completed in the near future. For instance, a job assignment engine 225 may identify or predict a set of upcoming data processing jobs (e.g., through analysis of trends in incoming data generated by data sources (e.g., 105a-b, 245, etc.) to be processed) and may likewise determine the processing and memory resources needed to complete these jobs within a particular window of time. From this determination, the job assignment engine 225 may determine, from capacity information determined by the capacity monitor, a number of devices possessing the capacity for performing these jobs. Additional policies and algorithms may be defined and considered by the job assignment engine 225 in determining which devices to use for which jobs, such as based on the priority of the job, the amount of capacity of the device, permissions and security of the device, communication channel characteristics (over which the job and corresponding data is to be communicated to the device handling the job), among other example considerations.

In one example implementation, a hot-pluggable job framework may be supported by the job assignment engine 225 to provide low-latency and flexible job offloading within a system. For instance, one or more runtime cores 230a-c may be provided, each core capable or setting aside memory and/or processing resources and providing additional core functionality upon which pluggable jobs, or job plugin code (e.g., 235a-b) may be run. Some devices (e.g., 105a) may host multiple runtime cores (e.g., 230y-z). A runtime core (e.g., 230x-z) may facilitate a respective plugin slot 260a-c in which various plugins may be run. In some cases, some plugins may be adapted to be run on and be compatible with only some runtime cores, while other job plugins may be compatible with other runtime cores. Further, placeholder plugins 240a-b may be provided as “dummy jobs,” which may be plugged-in to a runtime core as a placeholder to cause memory to be set aside and/or CPU processes to begin in advance of an substantive job plugin being inserted, or hot-plugged, into the runtime core, allowing the substantive job plugins to replace the placeholder plugin and begin substantive operation immediately, with little to no set-up time.

In some implementations, runtime cores (e.g., 230a) and job plugins (e.g., 235a) may be provided by the job assignment engine 225 to the host edge devices (e.g., 105a-b) that are to execute the corresponding jobs. For instance, a job assignment engine 225 may determine that one or more upcoming jobs are to be performed on a particular device (e.g., due to detected available capacity at the device) and the job assignment engine may prepare the particular device for offloading by provisioning one or more runtime cores on the particular device. Establishing the runtime cores on the device may introduce latency, so this may be done in advance of the actual job being assigned. In this sense, the runtime cores may be launched on a device proactively or predictively, and the job assignment engine 225 may determine or predict that a particular device will be used in offloading prior to identifying with particularity the specific job that will be offloaded to the device. With the runtime core(s) launched on the device, the job assignment engine 225 may then identify jobs (e.g., compatible with the launched runtime cores) and provide the corresponding job plugins to the device to be run on the launched runtime cores. In some instances, while waiting to identify the precise job (and job plugin) to assign to for offloading to a given device, the job assignment engine 225 may cause a placeholder plugin to be run on the runtime core. The placeholder plugin may allow the requisite computing resources of the device to be assigned (i.e., for later use by the eventual job plugin that is to replace the placeholder plugin), while actually utilizing little or no computing resources or generating no meaningful output, among other examples.

In some cases, rather than having a workload manager 210 provide runtime cores (e.g., 230a) and/or job plugins (e.g., 235a) and placeholder plugins (e.g., 240a) on an as-needed basis, at least some devices (e.g., 105b) may be pre-provisioned (e.g., by the workload manager 210) with a collection of runtime cores (e.g., 230b), job plugins (e.g., 235b), and/or placeholder plugins (e.g., 240b). These (e.g., 230b, 235b, 240b) may represent only a subset of the runtime cores and plugins that may be available, with the workload manager 210 supplementing and/or updating the runtime cores and job plugins from time-to-time. In other instances, no local copies may be maintained of runtime cores, job plugins, or placeholder plugins (e.g., as shown in device 105a), with these instead be provided by an external source (e.g., the workload manager 210, another device (e.g., 105b), or other source) on an as-needed basis or during certain windows when offloading is expected or otherwise anticipated, among other examples.

Continuing with the description of FIG. 2, each of the IoT devices (e.g., 105a,b) may include one or more processors (e.g., 266, 268), one or more memory elements (e.g., 270, 272), and one or more communications modules (e.g., 274, 276) to facilitate their participation in various IoT application deployments. Each device (e.g., 105a,b) can possess unique hardware, sensors (e.g., 110a), actuators (e.g., 115a), and other logic (e.g., 278, 280) to realize the intended function(s) of the device. For instance, devices may be provided with such resources as sensors of varying types (e.g., 110a), actuators (e.g., 115a) of varying types, energy modules (e.g., batteries, solar cells, etc.), computing resources (e.g., through a respective processor and/or software logic), security features, data storage, and other resources. Activity logic 278, 280 may include the programs, hardware logic, and/or software utilized by the device to control the other assets (e.g., 110a, 115a) of the device, perform various processing (e.g., to prepare and/or send data generated by sensors, synthesize inputs to direct actuator assets (e.g., 115a) on the device, etc.), and otherwise facilitate the special purpose functions of the respective device.

As noted above, edge devices (e.g., 105a-b) may be further provisioned with logic (e.g., 282, 284), to support offloading of data processing jobs onto the device for execution using computing resources (e.g., 266, 268, 270, 272, etc.) of the device. For instance, a runtime manager 282, 284 may provide an interface for a workload manager (e.g., 210) and may additional provide functionality for cooperating with a workload manager to report computing capacity of the edge device, launch a particular runtime core (e.g., 230x-y) on the host edge device (e.g., 105a-b), and plug and unplug various plugins (e.g., 235a-b, 240a-b) into the plugin slot (e.g., 260a-b) of the respective runtime core (e.g., 230x-y) in accordance with direction by the workload manager 210, among other example implementations.

Turning to FIG. 3, a simplified block diagram is provided to illustrate an example system in which a workload manager and pluggable job framework may be employed to provide flexible and low-latency job offloading. The particular example of FIG. 3, may represent an implementation involving a visual computing system. For instance, camera devices (or other sensor devices) (e.g., 305) may be provided, and generate data (e.g., video data) that is to be processed in the system. In one example, dedicated computing systems (e.g., 310) may be provided to handle at least some of the processing of the data generated by the sensor devices 305. The processing, in some cases, may be offloaded to other devices, such as a cloud system 320 or even the sensor devices (e.g., 305) themselves. Load balancers (e.g., 315) may be provided within the system to manage the assignment and offloading of jobs within the system. This may include the provisioning of runtime cores on one or more of these systems (e.g., 305, 310, 320), together with placeholder jobs to allow these runtime cores to be flexibly and swiftly transitioned to handling substantive jobs offloaded to the systems hosting the runtime cores.

In some applications, such as visual computing, job offloading may demand live (or nearly live) workload migration, which includes the process of encapsulating (at least in part) a workload and moving it over from one computing device to another with a certain predetermined objective (e.g., improved throughput and minimized latency). Successful workload migration may be dependent on the speed of the migration, portability of the workload, and density of the workload's execution. Speed may refer to the time that it takes to complete the workload migration and the desired or required start time for the workload. The time to migrate a workload may depend on workload size in the disk and the bandwidth of networks tasked to transfer the workload to the destination device(s), something of particular interest in the fog computing paradigm. Workload start time may be based on the types of start mechanism is used, such as hot start, warm start or cold start. Portability may be represented as a high-level abstraction that makes sure a migrated workload can be compatible in the target computing device. Density may correspond to the workload's memory footprint. For instance, the smaller the average memory footprint, the higher the workload density in a computing device. In one example, such as introduced above, a workload manager may be provided that employs plug-in abstraction to enable hot-swappable plugins as well as hot-pluggable runtimes (or “runtime cores”). Such solutions may primarily address issues concerning speed and density of workload migration and may assume a coherent platform (i.e., software toolchain and hardware) in the context of visual fog computing. Further, hot-swappable job plugins and runtime cores may be utilized to minimize workload size (speed) and workload memory footprint (density) to improve flexibility and latency concerns within a system. Further, placeholder, or dummy, plugins may be utilized to facilitate hot start, which can improve workload start time (speed).

While virtual machines and, more recently container-based execution environments, have been utilized to distribute and dynamically scale workloads, both of these solutions fail to adequately address applications utilizing heterogeneous host devices and latency sensitivity, such as fog-based visual computing systems. For instance, For instance, virtual machines (VMs), while realizing good portability, have significant migration overhead that sacrifices speed and density. Container-based technologies, on the other hand, represent improvements over VMs in terms of speed and density, but still suffer to meet low latency migration requirements of some applications due to containers mandating cold starts. Using a platform based on hot-pluggable runtime cores and job plugins, including placeholder job plugins, improved systems may be realized that facilitate job migration with simultaneously improved speed and density.

Turning to FIG. 4, a representation of job offloading within an improved system is presented. In particular, a series of simplified block diagrams 400a-f are shown, each showing the respective status of a particular runtime core 230 during the offloading of a series of example jobs. For instance, in block diagram 400a, a runtime core 230 is provided of a particular type. A runtime core 230 may be provisioned with one or more standard or static functional components 405, which may be utilized by, supplement, or support various types of job plugins that may be hosted by the runtime core. Indeed, the runtime core 230 may provide those elements required for a set of different jobs. Accordingly, different types of runtime cores may include different sets of static components and may support job plugins of different types. In the example of FIG. 4, at 400a, a runtime core 230 has been launched on a host system, such as an edge device (which may also participate in an IoT application). With the runtime core 230 established, the runtime core 230 may accept any one of a set of job plugins that are compatible with or would rely on the particular set of components (e.g., 405) provided on the runtime core. Placeholder plugins (e.g., 240) may be universally compatible with any one of a set of different runtime core types. In other instances, various placeholder plugins (e.g., 240) may be provided that are compatible with at least one (but not all) of multiple various runtime cores, among other example implementations. In 400a, a placeholder job 240 is inserted into the slot of the runtime core 230 implemented on an example edge device. The insertion of the placeholder job may cause memory of the host device to be allocated to the plugin 240 as well as initiate the components 405, such that they do not need to be initiated again before a substantive job is plugged-in to the runtime core.

In some cases, the placeholder plugin 240 may be implemented to before a type of “busy waiting” job, such as a spin lock. In such cases, CPU cycles may be utilized to perform the job of the placeholder plugin 240, although no meaningful work or memory usage will occur. In other implementations, the placeholder plugin 240 may be configured to perform a blocking operation or sleep operation, among other example implementations. In either case, the placeholder plugin 240 may allow memory to be allocated that is readily available to the current job plugin and support the launch (at the runtime core) of functionality and features (e.g., interfaces, codecs, metadata schemas, communications logic, etc.) relied upon by various different job plugins including the current job plugin. The placeholder plugin 240, however, may perform no meaningful operations such that the placeholder plugin 240 may be quickly removed (without negative consequence) and replaced with another plugin (e.g., 235x) configured to perform a substantive job (as shown at 400b). This transition can constitute the hot-swapping or hot plugging of the new job plugin 235. The hot plugged job 235 may then execute on the runtime core 230 to enable the particular job to be performed (and inevitably completed), as shown in 400c. Such jobs may be provided from another system, either as a delegation of the job from a system originally or typically tasked with completing it, as a migration from another device, or in connection with another offloading.

Continuing with the example of FIG. 4, when a job has been completed using the runtime core platform 230 and corresponding job plugin 235x, the job plugin may be removed. In some cases, the runtime core 230 may also be torn down (e.g., in cases when the processing capacity of the host is only temporary, with the host needing to reallocate the processing and memory resources used for the job to its core functions (or another job run on top of another type of runtime core), among other examples). In the example of 400d, a workload manager and/or the system hosting the runtime core may determine that the runtime core 230 used to host Job Plugin A may be kept open on the host to potentially host another job. In some cases, to facilitate this, the placeholder plugin 240 may be reinserted to replace the completed job plugin 235x, as in 400d. In other cases, if another job is available (that is compatible with the running runtime core) then a plugin for the other job may be hot-swapped for the previous plugin (e.g., 235x), among other examples. In the example of FIG. 4, the placeholder plugin 240 replaces the completed job plugin 235x and is allowed to passively run or sleep on the runtime core 230 (at 400e) until it is determined that the runtime core 230 should be closed or another job (implemented using job plugin 235y) is offloaded to the host (as in 400f).

Turning to FIG. 5, a simplified block diagram 500 is shown illustrating an example system where two or more different types of runtime cores (e.g., 230x, 230z) are provided within an environment. Instances of a first type of runtime core (e.g., 230x-y) may be configured with certain parameters and/or functional components (e.g., 405) to adapt such runtime cores to support a first type or types of job plugins. A different, second type of runtime core (e.g., 230z) may have a different set of functionality (e.g., components 505) and/or configuration parameters, making this type of runtime core (e.g., 230z) capable of supporting a second, different type of job plugin. In some cases, different types of runtime cores may support the same job plugin. However, running the same job plugin on different runtime core types may yield different functional results (e.g., with components of one runtime core (e.g., 230z) enabling some functions responsive to or accessible to the plugin that the components (e.g., 405) of another type of runtime core (e.g., 230x-7) do not support or provide).

In the particular example, some jobs may be dependent on, provide an input to, or work together with other jobs in a workload. For instance, in the example of FIG. 5, two jobs, provided by an example Plugin B (235y) and an example Plugin C (235z) may interoperate to provide a particular result within a given workload. The two cores (e.g., 230y-z) may be hosted on the same or different edge devices. A third core (e.g., 230x) may also be launched (based on an instruction from a workload manager), but before a specific job has been assigned to the device hosting the third core 230x. For instance, the workload manager may identify a particular runtime core to launch in connection with an expected or anticipated job or type of job. To prepare for the launch of this job, the workload manager may identify a host device with capacity to host the job and may select a particular runtime core (e.g., from cloud storage 510) to launch on the device. Further, while waiting for the ultimate job plugin to be offloaded to the device, the workload manager may additionally insert a placeholder plugin 240 into the slot of the runtime core 230x. This placeholder job can later facilitate the hot-plugging of the job plugin (e.g., selected by the workload manager and provided to the device from cloud storage 510) to replace the placeholder job 240 in the runtime core 230x, similar to the example illustrated on runtime core 230y.

Turning now to the example of FIG. 6, a simplified block diagram 600 is shown of an example set of jobs, which may be performed together (e.g., at least partially in parallel) or independently, using example runtime cores. In the particular example of FIG. 6, runtime cores are provided of types configured to support video or graphics processing in connection with visual computing applications. For example, instances (e.g., 230a-c) of various types of runtime cores may be provided, each with various sets of static components (e.g., 605, 610, 615, 620, 625, 630, 635, 640, 645, 650a-c). For instance, runtime core may include a video capture component (e.g., to accept an input) 605, a transcoding (codec) component 610, a network communication component 615 (e.g., a component supporting network transport of video such as Real Time Streaming Protocol (RTSP)), and a metadata schema component 650a (e.g., which is common across interoperating runtime cores (e.g., 260y-z) and used for translation and/or standardization of data to be passed between the cores for processing by respective job plugins (e.g., 235y-z, etc.). The runtime core component may be selected to enable certain types of interactions between jobs. For instance, an RTSP component 615 may be provided on one runtime core 230a to enable communication of job results for use in other jobs (hosted on a different runtime core (e.g., 230b) also possessing an RTSP component 620, among other examples. Further, each of the runtime cores may likewise be adapted to host various types or instances of job plugins 235x-z capable of performing various corresponding jobs, including placeholder plugins. While the runtime cores (e.g., 230a-c) represent the static or core functionality for a job, the job plugins (e.g., 235x-z) may represent the flexible or changing elements of the job, providing hot-pluggable runtimes, communication abstraction, runtime lifecycle management, among other example features.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

FIG. 7 is a simplified flowchart 700 illustrating an example technique for offloading jobs of a workload on another device, such as an edge computing device in a fox computing system, using a pluggable runtime platform. For instance, availability of computing resources may be detected 705 (e.g., by an external workload management system or by the device itself, which may cause the device to advertise its availability to a workload management system, etc.). Based on the detected availability of device, a runtime core may be loaded 710 on the device. In some cases, the runtime core may be hosted on the device itself and loaded, as needed, on the device. In other cases, a workload management system may provide the runtime core (e.g., over a network) to the device, based on workloads (and jobs included in these workloads), as managed by the workload management system. A placeholder plugin may then be inserted 715, or loaded, into a slot of the runtime core adapted to accept potentially any one of a plurality of different plugins. The placeholder plugin may not perform any meaningful work, but may serve to reserve at least a portion of the available computing resources of the device until a job is identified to be offloaded to the device.

A particular job may be identified 720 within a particular offload that corresponds to amount of computing capacity at the device and/or the runtime core loaded on the device. A job plugin corresponding to the particular job may likewise be identified and may be caused 725 to be hotplugged on the runtime core and replace the placeholder plugin. The hotplugged job plugin may utilize the same computing resources reserved using the placeholder plugin. In some cases, the hotplugged plugin may be pre-provisioned in memory of the device (e.g., from a prior running of the job or in connection with the provisioning of the runtime core, among other examples). In other cases, a workload manager may identify and provide (e.g., push or upload) the job plugin to the device, among other examples. The job plugin may then be run 730 using the runtime core.

Upon conclusion of the job (or a determination that the device is no longer needed and is to cease performance of the job), a determination 735 can be made as to whether the device is still needed for using offloading jobs of the same or a different workload. If it is determined that the device is no longer needed, the job plugin and runtime core may be torn down 740 to free up the computing resources of the device for other tasks (e.g., its primary processes, which in some implementations may be specialized functions in an IoT environment, among other examples). If it is determined that the device is needed, it can be determined 745 whether the next job to be offloaded to the device has been selected and is ready or not. If the next job is not yet ready, the placeholder plugin may be reinserted and run (at 715) on the runtime core until the job is identified (e.g., at 720) and ready to be hotplugged (e.g., at 725) on the runtime core. On the other hand, if the next job is ready, the corresponding job plugin may be identified and caused 750 to be hotplugged on the runtime core to replace the previous job plugin (and reuse the same computing resource originally reserved using the placeholder plugin), among other example implementations.

FIGS. 8-9 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 8-9.

FIG. 8 is an example illustration of a processor according to an embodiment. Processor 800 is an example of a type of hardware device that can be used in connection with the implementations above. Processor 800 may be any type of processor, such as a microprocessor, an embedded processor, a digital signal processor (DSP), a network processor, a multi-core processor, a single core processor, or other device to execute code. Although only one processor 800 is illustrated in FIG. 8, a processing element may alternatively include more than one of processor 800 illustrated in FIG. 8. Processor 800 may be a single-threaded core or, for at least one embodiment, the processor 800 may be multi-threaded in that it may include more than one hardware thread context (or “logical processor”) per core.

FIG. 8 also illustrates a memory 802 coupled to processor 800 in accordance with an embodiment. Memory 802 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 800 can execute any type of instructions associated with algorithms, processes, or operations detailed herein. Generally, processor 800 can transform an element or an article (e.g., data) from one state or thing to another state or thing.

Code 804, which may be one or more instructions to be executed by processor 800, may be stored in memory 802, or may be stored in software, hardware, firmware, or any suitable combination thereof, or in any other internal or external component, device, element, or object where appropriate and based on particular needs. In one example, processor 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor 800 can also include execution logic 814 having a set of execution units 816a, 816b, 816n, etc. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor 800 allows out of order execution but requires in order retirement of instructions. Retirement logic 820 may take a variety of known forms (e.g., re-order buffers or the like). In this manner, processor 800 is transformed during execution of code 804, at least in terms of the output generated by the decoder, hardware registers and tables utilized by register renaming logic 810, and any registers (not shown) modified by execution logic 814.

Although not shown in FIG. 8, a processing element may include other elements on a chip with processor 800. For example, a processing element may include memory control logic along with processor 800. The processing element may include I/O control logic and/or may include I/O control logic integrated with memory control logic. The processing element may also include one or more caches. In some embodiments, non-volatile memory (such as flash memory or fuses) may also be included on the chip with processor 900.

FIG. 9 illustrates a computing system 900 that is arranged in a point-to-point (PtP) configuration according to an embodiment. In particular, FIG. 9 shows a system where processors, memory, and input/output devices are interconnected by a number of point-to-point interfaces. Generally, one or more of the computing systems described herein may be configured in the same or similar manner as computing system 900.

Processors 970 and 980 may also each include integrated memory controller logic (MC) 972 and 982 to communicate with memory elements 932 and 934. In alternative embodiments, memory controller logic 972 and 982 may be discrete logic separate from processors 970 and 980. Memory elements 932 and/or 934 may store various data to be used by processors 970 and 980 in achieving operations and functionality outlined herein.

Processors 970 and 980 may be any type of processor, such as those discussed in connection with other figures. Processors 970 and 980 may exchange data via a point-to-point (PtP) interface 950 using point-to-point interface circuits 978 and 988, respectively. Processors 970 and 980 may each exchange data with a chipset 990 via individual point-to-point interfaces 952 and 954 using point-to-point interface circuits 976, 986, 994, and 998. Chipset 990 may also exchange data with a high-performance graphics circuit 938 via a high-performance graphics interface 939, using an interface circuit 992, which could be a PtP interface circuit. In alternative embodiments, any or all of the PtP links illustrated in FIG. 9 could be implemented as a multi-drop bus rather than a PtP link.

Chipset 990 may be in communication with a bus 920 via an interface circuit 996. Bus 920 may have one or more devices that communicate over it, such as a bus bridge 918 and I/O devices 916. Via a bus 910, bus bridge 918 may be in communication with other devices such as a user interface 912 (such as a keyboard, mouse, touchscreen, or other input devices), communication devices 926 (such as modems, network interface devices, or other types of communication devices that may communicate through a computer network 960), audio I/O devices 914, and/or a data storage device 928. Data storage device 928 may store code 930, which may be executed by processors 970 and/or 980. In alternative embodiments, any portions of the bus architectures could be implemented with one or more PtP links.

The computer system depicted in FIG. 9 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a sample that includes software code, generating a control flow graph for each of a plurality of functions included in the sample, and identifying, in each of the functions, features corresponding to instances of a set of control flow fragment types. The identified features can be used to generate a feature set for the sample from the identified features.

These and other embodiments can each optionally include one or more of the following features. The features identified for each of the functions can be combined to generate a consolidated string for the sample and the feature set can be generated from the consolidated string. A string can be generated for each of the functions, each string describing the respective features identified for the function. Combining the features can include identifying a call in a particular one of the plurality of functions to another one of the plurality of functions and replacing a portion of the string of the particular function referencing the other function with contents of the string of the other function. Identifying the features can include abstracting each of the strings of the functions such that only features of the set of control flow fragment types are described in the strings. The set of control flow fragment types can include memory accesses by the function and function calls by the function. Identifying the features can include identifying instances of memory accesses by each of the functions and identifying instances of function calls by each of the functions. The feature set can identify each of the features identified for each of the functions. The feature set can be an n-graph.

Further, these and other embodiments can each optionally include one or more of the following features. The feature set can be provided for use in classifying the sample. For instance, classifying the sample can include clustering the sample with other samples based on corresponding features of the samples. Classifying the sample can further include determining a set of features relevant to a cluster of samples. Classifying the sample can also include determining whether to classify the sample as malware and/or determining whether the sample is likely one of one or more families of malware. Identifying the features can include abstracting each of the control flow graphs such that only features of the set of control flow fragment types are described in the control flow graphs. A plurality of samples can be received, including the sample. In some cases, the plurality of samples can be received from a plurality of sources. The feature set can identify a subset of features identified in the control flow graphs of the functions of the sample. The subset of features can correspond to memory accesses and function calls in the sample code.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is a machine accessible storage medium having instructions stored thereon, where the instructions when executed on a machine, cause the machine to: detect availability of computing resources on a particular device in a network; cause a runtime core to be loaded on the particular device, where the runtime core is configured to support hot-plugging of code embodying any one of a plurality of jobs; cause first code including a placeholder job to be run on the runtime core to reserve at least a portion of the computing resources of the particular device; identify a particular one of the plurality of jobs to be run on the particular device; and replace the first code with second code corresponding to the particular job to replace the placeholder job on the runtime core.

Example 2 may include the subject matter of example 1, where causing the first code to be run on the runtime core includes allocating a portion of memory of the particular device for use by the first code, and the second code also uses the allocated portion of memory.

Example 3 may include the subject matter of example 2, where the detecting availability of computing resources includes determining that the portion of memory is available on the particular device.

Example 4 may include the subject matter of any one of examples 1-3, where replacing the first code with the second code on the runtime core includes hotplugging the second code on the runtime core and the first code enables the hotplugging of the second code.

Example 5 may include the subject matter of any one of examples 1-4, where the second code includes a particular job plugin compatible with the runtime core, and the particular job plugin is one of a plurality of job plugins corresponding to the plurality of jobs.

Example 6 may include the subject matter of any one of examples 1-5, where the instructions, when executed, further cause the machine to determine a need for additional computing capacity to perform a workload including the particular job, and the second code is to be run on the particular device based on the need.

Example 7 may include the subject matter of example 6, where performance of the particular job is to be offloaded from another system to the particular device, and the need corresponds to a shortage of computing capacity at the other system.

Example 8 may include the subject matter of example 7, where the particular device and the other system each include a respective edge device.

Example 9 may include the subject matter of example 7, where the other system includes a server system and the particular device includes a special purpose edge device.

Example 10 may include the subject matter of any one of examples 1-9, where the instructions, when executed, further cause the machine to: determine that performance of the particular job using the second code is completed; and replace the second code with the first code on the runtime core.

Example 11 may include the subject matter of example 10, where the instructions, when executed, further cause the machine to: identify another one of the plurality of jobs to be run on the particular device; and replace the first code with third code corresponding to the other job to replace the placeholder job on the runtime core with the third code and cause the other job to be performed, where the first code enables hotplugging of the third code on the runtime core.

Example 12 may include the subject matter of any one of examples 1-11, where the instructions, when executed, further cause the machine to: determine that performance of the particular job using the second code is completed; and replace the second code with third code to perform another one of the plurality of jobs on the runtime core.

Example 13 may include the subject matter of example 12, where replacing the second code with third code includes hotplugging the third code on the runtime core.

Example 14 may include the subject matter of any one of examples 1-13, where the placeholder job includes a spin lock process.

Example 15 may include the subject matter of any one of examples 1-14, where the placeholder job includes a sleep process.

Example 16 is a method including: detecting availability of computing resources on a particular device in a network; causing a runtime core to be loaded on the particular device, where the runtime core is configured to support hot-plugging of code embodying any one of a plurality of jobs; causing first code including a placeholder job to be run on the runtime core to reserve at least a portion of the computing resources of the particular device; identifying a particular one of the plurality of jobs to be run; and replacing the first code with second code corresponding to the particular job to replace the placeholder job on the runtime core.

Example 17 may include the subject matter of example 16, where causing the first code to be run on the runtime core includes allocating a portion of memory of the particular device for use by the first code, and the second code also uses the allocated portion of memory.

Example 18 may include the subject matter of example 17, where the detecting availability of computing resources includes determining that the portion of memory is available on the particular device.

Example 19 may include the subject matter of any one of examples 16-18, where replacing the first code with the second code on the runtime core includes hotplugging the second code on the runtime core and the first code enables the hotplugging of the second code.

Example 20 may include the subject matter of any one of examples 16-19, where the second code includes a particular job plugin compatible with the runtime core, and the particular job plugin is one of a plurality of job plugins corresponding to the plurality of jobs.

Example 21 may include the subject matter of any one of examples 16-20, further including determining a need for additional computing capacity to perform a workload including the particular job, and the second code is to be run on the particular device based on the need.

Example 22 may include the subject matter of example 21, where performance of the particular job is to be offloaded from another system to the particular device, and the need corresponds to a shortage of computing capacity at the other system.

Example 23 may include the subject matter of example 22, where the particular device and the other system each include a respective edge device.

Example 24 may include the subject matter of example 22, where the other system includes a server system and the particular device includes a special purpose edge device.

Example 25 may include the subject matter of any one of examples 16-24, further including: determining that performance of the particular job using the second code is completed; and replacing the second code with the first code on the runtime core.

Example 26 may include the subject matter of example 25, further including: identifying another one of the plurality of jobs to be run on the particular device; and replacing the first code with third code corresponding to the other job to replace the placeholder job on the runtime core with the third code and cause the other job to be performed, where the first code enables hotplugging of the third code on the runtime core.

Example 27 may include the subject matter of any one of examples 16-26, further including: determining that performance of the particular job using the second code is completed; and replacing the second code with third code to perform another one of the plurality of jobs on the runtime core.

Example 28 may include the subject matter of example 27, where replacing the second code with third code includes hotplugging the third code on the runtime core.

Example 29 may include the subject matter of any one of examples 16-28, where the placeholder job includes a spin lock process.

Example 30 may include the subject matter of any one of examples 16-29, where the placeholder job includes a sleep process.

Example 31 is a system including means to perform the method of any one of examples 16-30.

Example 32 is an apparatus including: a processor device; memory; a communication module to receive messages from a workload management system; and runtime logic. The runtime logic may: implement a runtime core configured to accept and run any one of a plurality of different job plugins, where each of the plurality of job plugins is configured to perform a corresponding job; run a placeholder job plugin on the runtime core responsive to a first message from the workload management system; load a particular one of the plurality of job plugins to replace the placeholder job plugin on the runtime core responsive to a second message from the workload management system; and run the particular job plugin on the runtime core to perform a particular job corresponding to the particular job plugin.

Example 33 may include the subject matter of example 32, further including activity logic executable by the processor to perform a special purpose function of the apparatus.

Example 34 may include the subject matter of example 33, further including at least one of a sensor or an actuator, where the activity logic uses the sensor or actuator.

Example 35 may include the subject matter of example 33, where the runtime core, particular job plugin, and the placeholder job plugin are run using excess computing capacity of the apparatus left after computing capacity used to perform the special purpose function.

Example 36 may include the subject matter of any one of examples 32-35, where running the placeholder job allows the particular job to be hotplugged onto the runtime core and perform the particular job immediately upon loading.

Example 37 is a system including: an endpoint device including a computer processor; and a workload manager. The workload manager may be executable to: detect availability of computing resources on the endpoint device; cause a runtime core to be loaded on the endpoint device, where the runtime core is configured to support hot-plugging of code embodying any one of a plurality of jobs; cause first code including a placeholder job to be run on the runtime core; identify a particular one of the plurality of jobs to be run; and replace the first code with second code corresponding to the particular job to replace the placeholder job on the runtime core.

Example 38 may include the subject matter of example 37, where the endpoint device includes a sensor and logic to process data generated by the sensor.

Example 39 may include the subject matter of any one of examples 37-38, where the endpoint device includes a mobile computing device.

Example 40 may include the subject matter of any one of examples 37-39, where the endpoint device is one of a plurality of devices on a network, and the workload manager is to monitor the plurality of devices to determine devices having excess computing capacity to handle offloading of jobs in the plurality of jobs to a corresponding device.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine accessible storage medium having instructions stored thereon, wherein the instructions when executed on a machine, cause the machine to:
detect availability of computing resources on a particular device in a network;
cause a runtime core to be loaded on the particular device, wherein the runtime core is configured to support hot-plugging of code embodying any one of a plurality of jobs;
cause first code comprising a placeholder job to be run on the runtime core to reserve at least a portion of the computing resources of the particular device;
identify a particular one of the plurality of jobs to be run on the particular device; and
replace the first code with second code corresponding to the particular job to replace the placeholder job on the runtime core.

2. The storage medium of claim 1, wherein causing the first code to be run on the runtime core comprises allocating a portion of memory of the particular device for use by the first code, and the second code also uses the allocated portion of memory.

3. The storage medium of claim 2, wherein the detecting availability of computing resources comprises determining that the portion of memory is available on the particular device.

4. The storage medium of claim 1, wherein replacing the first code with the second code on the runtime core comprises hotplugging the second code on the runtime core and the first code enables the hotplugging of the second code.

5. The storage medium of claim 1, wherein the second code comprises a particular job plugin compatible with the runtime core, and the particular job plugin is one of a plurality of job plugins corresponding to the plurality of jobs.

6. The storage medium of claim 1, wherein the instructions, when executed, further cause the machine to determine a need for additional computing capacity to perform a workload comprising the particular job, and the second code is to be run on the particular device based on the need.

7. The storage medium of claim 6, wherein performance of the particular job is to be offloaded from another system to the particular device, and the need corresponds to a shortage of computing capacity at the other system.

8. The storage medium of claim 7, wherein the particular device and the other system each comprise a respective edge device.

9. The storage medium of claim 7, wherein the other system comprises a server system and the particular device comprises a special purpose edge device.

10. The storage medium of claim 1, wherein the instructions, when executed, further cause the machine to:
determine that performance of the particular job using the second code is completed; and
replacing the second code with the first code on the runtime core.

11. The storage medium of claim 10, wherein the instructions, when executed, further cause the machine to:
identify another one of the plurality of jobs to be run on the particular device; and
replace the first code with third code corresponding to the other job to replace the placeholder job on the runtime core with the third code and cause the other job to be performed, wherein the first code enables hotplugging of the third code on the runtime core.

12. The storage medium of claim 1, wherein the instructions, when executed, further cause the machine to:
determine that performance of the particular job using the second code is completed; and
replace the second code with third code to perform another one of the plurality of jobs on the runtime core.

13. The storage medium of claim 12, wherein replacing the second code with third code comprises hotplugging the third code on the runtime core.

14. The storage medium of claim 1, wherein the placeholder job comprises a spin lock process.

15. The storage medium of claim 1, wherein the placeholder job comprises a sleep process.

16. A method comprising:
detecting availability of computing resources on a particular device in a network;
causing a runtime core to be loaded on the particular device, wherein the runtime core is configured to support hot-plugging of code embodying any one of a plurality of jobs;
causing first code comprising a placeholder job to be run on the runtime core to reserve at least a portion of the computing resources of the particular device;
identifying a particular one of the plurality of jobs to be run; and
replacing the first code with second code corresponding to the particular job to replace the placeholder job on the runtime core.

17. (canceled)

18. (canceled)

19. (canceled)

20. (canceled)

21. (canceled)

22. (canceled)

23. A system comprising:
an endpoint device comprising a computer processor; and
a workload manager, wherein the workload manager is executable to:
detect availability of computing resources on the endpoint device;
cause a runtime core to be loaded on the endpoint device, wherein the runtime core is configured to support hot-plugging of code embodying any one of a plurality of jobs;
cause first code comprising a placeholder job to be run on the runtime core;
identify a particular one of the plurality of jobs to be run; and
replace the first code with second code corresponding to the particular job to replace the placeholder job on the runtime core

24. The system of claim 23, wherein the endpoint device comprises a sensor and logic to process data generated by the sensor.

25. The system of claim 23, wherein the endpoint device comprises a mobile computing device.

26. The system of claim 23, wherein the endpoint device is one of a plurality of devices on a network, and the workload manager is to monitor the plurality of devices to determine devices having excess computing capacity to handle offloading of jobs in the plurality of jobs to a corresponding device.
